(19) United States
(12) Patent Application Publication
(10) Pub. No.: US 2005/0131825 A1
(43) Pub. Date: Jun. 16, 2005

(54) Distributed knowledge management system

(76) Inventor: Vasu Vijay, Richardson, TX (US)

Correspondence Address: Stephen R. Loe;The Law Office of Stephen R. Loe, P.O. Box 649, Frisco, TX, 75034, US

(21) Appl. No.: 10/736,251

(22) Filed: Dec. 15, 2003

(51) Int. Cl. G06F 17/60

(52) U.S. Cl. 705/44

(57) ABSTRACT

A system for managing digital assets in a distributed data processing system is provided. In one embodiment, the system includes a network of data processing systems, a plurality of local knowledge management servers connected to the network wherein each of the plurality of local knowledge management servers is connected to and maintains a local digital asset repository, a central knowledge management server, and a central registry of digital assets. Each of the plurality of local knowledge management servers sends location and identifying information concerning a digital asset to the central knowledge management server whenever a digital asset is saved to a local digital asset repository corresponding to an appropriate one of the plurality of knowledge management servers. The central knowledge management server stores the location and identifying information concerning the digital asset in the central registry of digital assets.

### CROSS REFERENCE TO RELATED APPLICATIONS

The present application is related to co-pending, commonly assigned U.S. patent application Ser. No. ______ (Attorney Docket No. LEDS.00119) entitled “Nomadic Digital Asset Retrieval System” filed even date herewith. The content of the cross referenced co-pending application is hereby incorporated herein by reference for all purposes.

### BACKGROUND OF THE INVENTION

1. Technical Field

The present invention relates generally to computer software and, more particularly, to management of knowledge in the form of digital assets in a distributed data processing system.

2. Description of Related Art

One aspect of Knowledge Management consists of acquiring, storing and retrieving digital assets that consist of separate or linked digital objects including text, audio, video, photographs, graphics and other related objects. In any corporation or enterprise, each of the activities of acquisition, storage, retrieval and use is performed by a different set of people, who could be in the same or different business units, and located at one or more geographically dispersed offices.

The processes performed in the course of these activities are defined by informal and/or formal workflows that could be embedded in a Digital Asset Management System.

Digital Assets form a significant component of an organization's knowledge base and so it is important to foster collaboration and to promote re-use of digital assets. At the same time, a key objective is to enable each of the individuals to retain their independence and creativity without being constrained by the technical environment. It would be counter-productive to institutionalize the aspects of creation and re-use of digital assets, by imposing administrative and technology constraints.

All corporations are generating and acquiring considerable amounts of multi-media assets—from audio clips, phone messages, electronically delivered faxes, videos, still photographs, marketing collateral with a combination of multi-media objects. One approach to organizing all these digital assets and making them available in a knowledge management setting is to consolidate all these assets in a large repository, in a centralized location. The next step would be to provide a smart search engine that would allow for searching through this immense catalog of objects to facilitate retrieval. Though this is possible, it is not practical. As has been experienced before, even though a centralized system exists, pockets of local assets develop over time and the corporation ends up in the same place that it started from—rendering the centralized system less powerful and relevant than expected.

Therefore, it would be desirable to have a centralized oversight and control of distributed digital assets of an enterprise, while enabling speedy search and retrieval techniques for promoting asset life extensions and re-use.

Significantly, such a system is supported by human behavior, where one tends to utilize immediately available local assets/resources before engaging in enterprise level searches for relevant assets/resources.

### SUMMARY OF THE INVENTION

The present invention provides a system for managing digital assets in a distributed data processing system. In one embodiment, the system includes a network of data processing systems, a plurality of local knowledge management servers connected to the network wherein each of the plurality of local knowledge management servers is connected to and maintains a local digital asset repository directly or through a Digital Asset Management software package, a central knowledge management server, and a central registry of knowledge assets. Each of the plurality of local knowledge management servers sends location and identifying information concerning a digital asset to the central knowledge management server whenever a digital asset is saved to a local digital asset repository corresponding to an appropriate one of the plurality of knowledge management servers. The central knowledge management server stores the location and identifying information concerning the digital asset in the central registry of digital assets.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram illustrating software architecture of a cKM application that may be implemented on a cKM server in accordance with one embodiment of the present invention;

FIG. 4 depicts a block diagram illustrating an exemplary lKM application architecture that may be implemented on a lKM server in accordance with one embodiment of the present invention;

FIG. 5 depicts a block diagram illustrating an exemplary connection pattern for an lKM server in accordance with one embodiment of the present invention;

FIG. 6 depicts a block diagram illustrating retrieval of digital assets in accordance with one embodiment of the present invention;

FIG. 7 depicts a process flow and program function diagram illustrating registration and storage of a digital asset in accordance with one embodiment of the present invention; and

FIG. 8 depicts a process flow and program function diagram illustrating the retrieval of a digital asset in accordance with one embodiment of the present invention.

### DETAILED DESCRIPTION OF THE PREFERRED EMBODIMENT

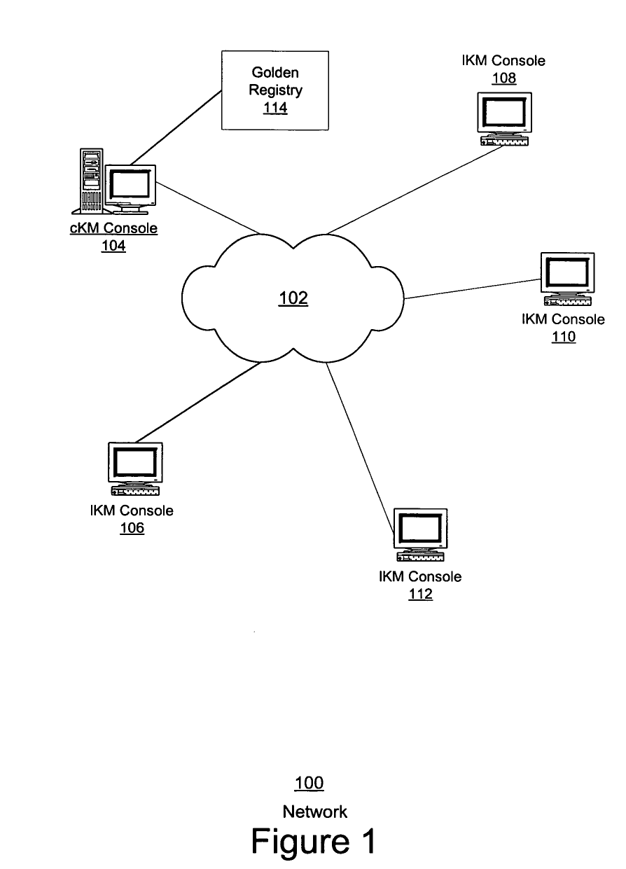

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, central Knowledge Management (cKM) server 104 is connected to network 102, along with local Knowledge Management (lKM) servers 106-112. In addition, a centralized “Golden” Registry 114 is connected to cKM server 104. The “golden” registry 114 is a centralized registry of digital assets that exist across the organization from which all assets must be checked-in and checked-out for use. Digital assets may consist of separate or linked digital objects including text, audio, video, photographs, graphics, and other related objects.

lKM software runs on lKM servers 106-112 in the different locations of the enterprise offices where digital assets are created, acquired, stored, or retrieved. This may also include third party servers on which digital assets are created or re-purposed for consumption by the enterprise. The role of the lKM servers 106-112 is to perform automatic check-in/check-out of the digital assets with the central “Golden” registry 114, update registry 114, perform local security checks, comply with global security checks, determine the location of the requested digital asset, retrieve requested digital assets, and update the local asset management software (if any). In addition to these tasks, the lKM servers 106-112 possess a user interface that is easy to use and allows the user to perform additional administrative tasks and set up local work flows as needed. The lKM servers 106-112 are also responsible for the redundant saving of additional copies of the digital assets across lKM peers to ensure enterprise continuity. The lKM server 106-112 operate in real-time mode, but the user has the ability to set up specific tasks, such as, for example, retrieval of multiple assets and automatic cataloging of newly arrived local assets, to be performed in a batch mode or off-line. The lKM interfaces with other local applications including package digital asset management systems like Artesia (if any has been implemented on that site) that perform specific tasks like asset management, archiving, backup and restore, digital asset acquisition, ingestion and formatting, directory services, security services, rights management and such.

The cKM software is an application that runs on a central cKM server 104 and performs several functions including authenticating the lKM servers 106-112; providing access to the “golden” registry 114; enabling automated check-in/check-out; version control; shadow registry for redundant copies; tracking usage of digital assets; capturing statistics of and about the digital asset; generating reports based on asset (usage, type), business unit, geography, revenues and similar metrics; ensuring global security checking; and a separate publish/subscribe mechanism for push/pull of digital assets (or asset information) for global or group broadcast of the asset (or asset information).

The lKM servers 106-112 and the cKM server 104 use a common open interface architecture that allows for each of them to interface with common off-the-shelf digital asset management products as well as related products like content management, portals, powerful context based multi-media search engines, DBMSs, systems management tools, reporting tools, data warehouse/data marts, ERP, SCM, and CRM suites.

The cKM server 104 is set up as a dashboard and has drill-down capability to obtain the necessary detail.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Appropriate use of encryption and/or Virtual Private Networks (VPNs) may be utilized in order to provide the necessary level of security for data transmitted across the Internet. Of course, distributed data processing system 100 also may be implemented as a number of different types of networks such as, for example, an intranet or a local area network.

FIG. 1 is intended as an example and not as an architectural limitation for the processes of the present invention.

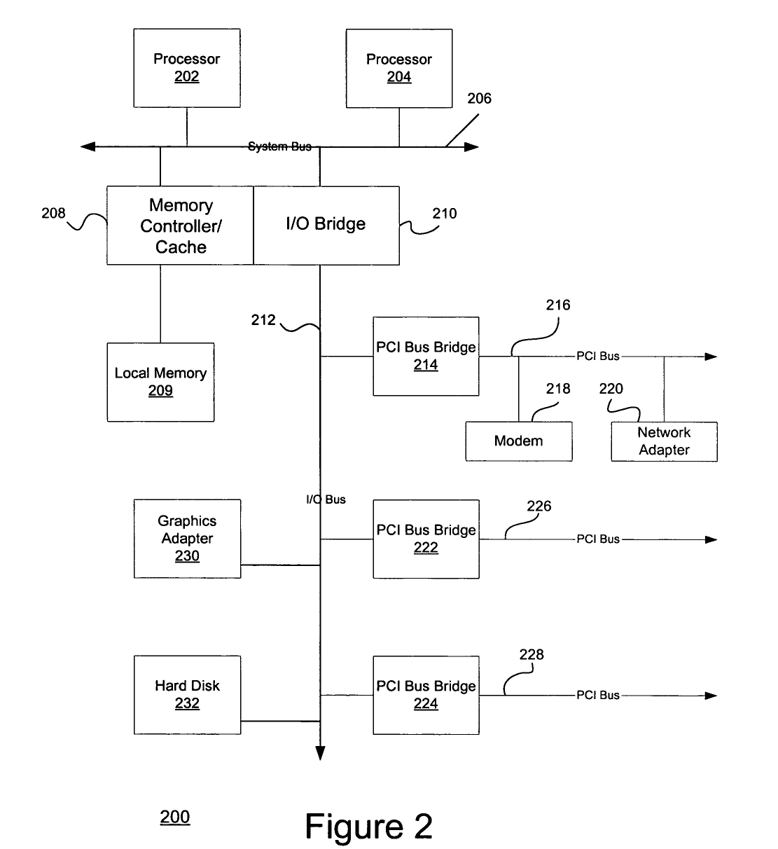

Referring to FIG. 2, a block diagram of a data processing system which may be implemented as a server, such as any of servers 104-112 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly. Depending on whether server 200 is implemented as cKM server 104 or any one of lKM servers 106-112, appropriate cKM or lKM software is stored, for example, on hard disk 232 and loaded into local memory 209 for execution by processor 202 and/or processor 204.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

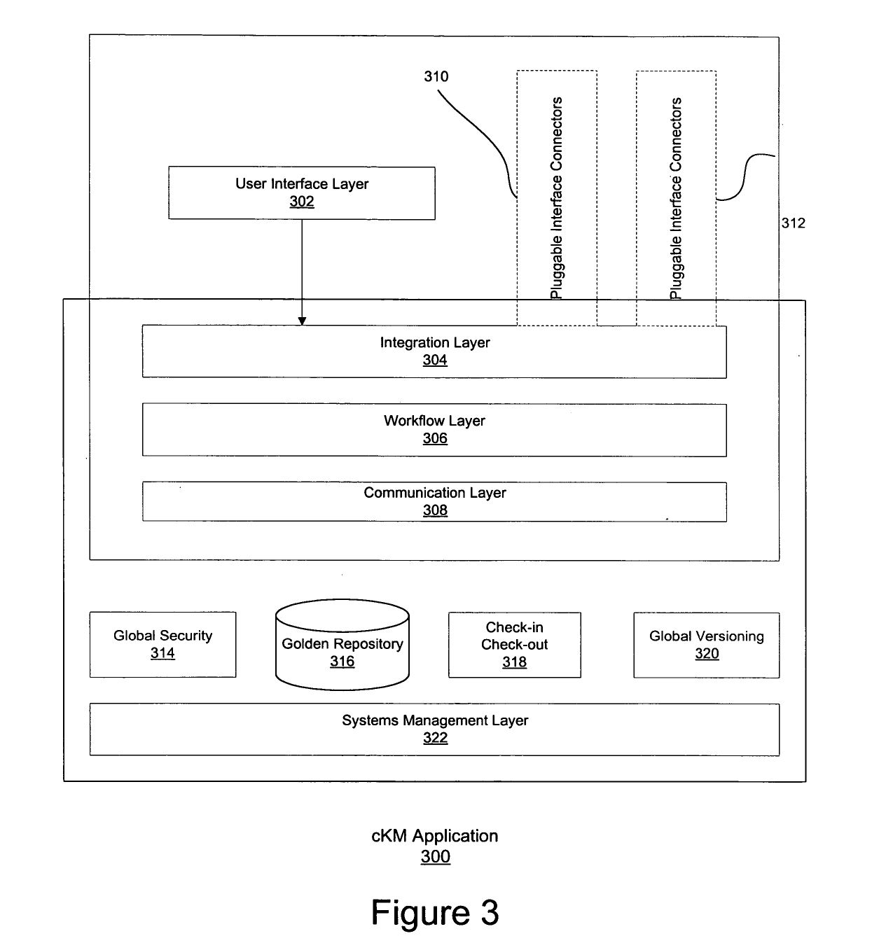

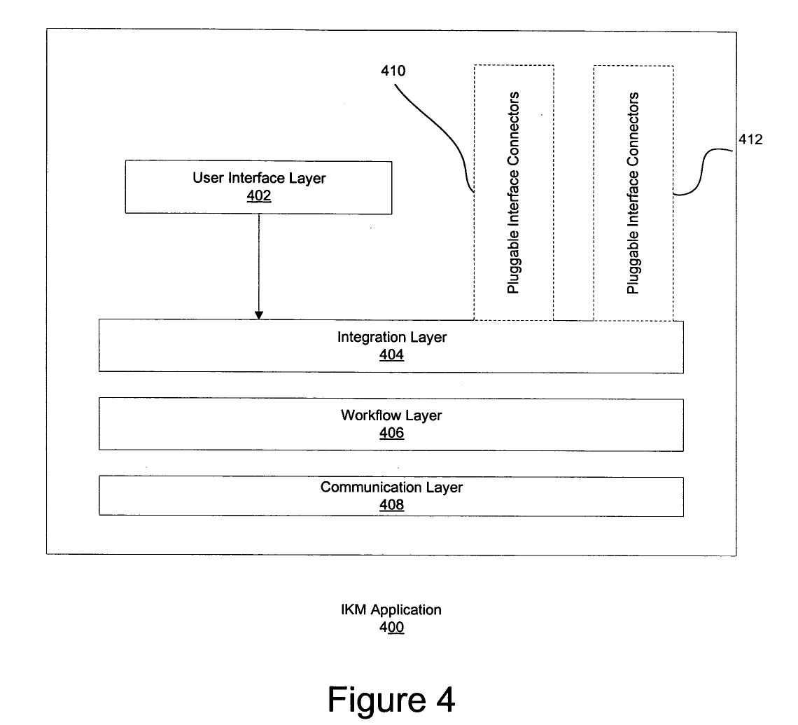

With reference now to FIG. 3, a block diagram illustrating software architecture of a cKM application that may be implemented on cKM server 104 in FIG. 4 is depicted in accordance with one embodiment of the present invention.

The cKM software essentially consists of the lKM software plus (global security 314, golden repository 316, check-in/check-out capabilities 318, versioning 320 and application management modules 322). The cKM application 300 because it includes the lKM software also includes an integration layer 304, a workflow layer 306, and a communication layer 308. The cKM application 300 also includes pluggable interface connection extensions 310 and 312 that can connect to portal software, ingestion software, content management software and a variety of database management systems. Golden Repository 316 includes a full fledged multi-media repository as well as a robust quick-search indexing mechanism. If a pre-existing multi-media repository exists (eg. Like Artesia) then the pluggable interface connection extension 310 or 312 for Artesia is used instead. In all cases, the “golden repository” 316 will always exist.

The cKM application 300 architecture depicted in FIG. 3 is intended merely as an example and not as an architectural limitation of the present invention. Those of ordinary skill in the art will appreciate that the components depicted in FIG. 3 may vary.

With reference now to FIG. 4, a block diagram illustrating an exemplary lKM application architecture that may be implemented on any of lKM servers 106-112 in FIG. 1 is depicted in accordance with one embodiment of the present invention.

lKM application 400 includes a user interface layer 402 that allows a user to request and receive digital assets from the distributed knowledge management system. User interface layer 402 also allows a user to perform additional administrative tasks and set up local work flows as needed. lKM application 400 also includes an integration layer 404, a workflow layer 406, and a communication layer 408. lKM application 400 may also include pluggable interface connectors 410 and 412. The integration layer 404 consists of a set of standard entry and exit points into and out of the application facilitating easy integration of additional functionality, varied software packages and the building of pluggable interface connection extensions.

The workflow layer 406 leverages the tools that may already be available in the environment and acts as a pass through. If no such tools exist, then the workflow layer 406 provides a simple mechanism to set up routing of digital assets in the lKM context.

The communication layer 408 enables communication between lKMs and also between an lKM and the cKM.

Interaction with the Operating system, drivers, output devices and such is handled by the systems management layer.

The lKM application 400 architecture depicted in FIG. 4 is intended merely as an example and not as an architectural limitation of the present invention. Those of ordinary skill in the art will appreciate that the components depicted in FIG. 4 may vary.

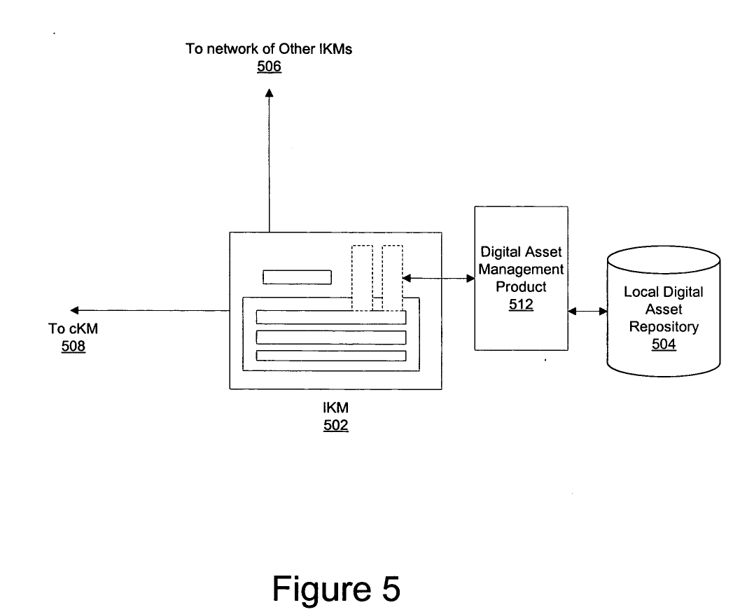

With reference now to FIG. 5, a block diagram illustrating an exemplary connection pattern for an lKM server is depicted in accordance with one embodiment of the present invention. Local digital assets may be stored on local digital asset repository 504. Local digital asset repository 504 is connected to an lKM server 502 either directly or through an existing digital asset management package 512 (as illustrated) which is in turn connected to other lKMs 506 as well as to the cKM 508. Digital content stored on local digital asset repository 504 is registered with the “golden” registry, such as, for example, “golden” registry 114 in FIG. 1, through cKM 508.

Thus, users from other lKMs 506 may access the local content stored on repository 504 by querying the “golden” registry through cKM 508 to determine where the requested digital content is stored and then accessing it through lKM server 502. If not all users within the enterprise may access all digital content, then prior to providing the requested digital content, the cKM 508 or the lKM 502 verifies that the requesting user is authorized to receive the requested digital content.

Thus, digital assets may continue to be stored locally, but are registered with a central “golden” registry so that users in other parts of the enterprise may be made aware of and have access to digital assets created and/or stored in another part of the enterprise.

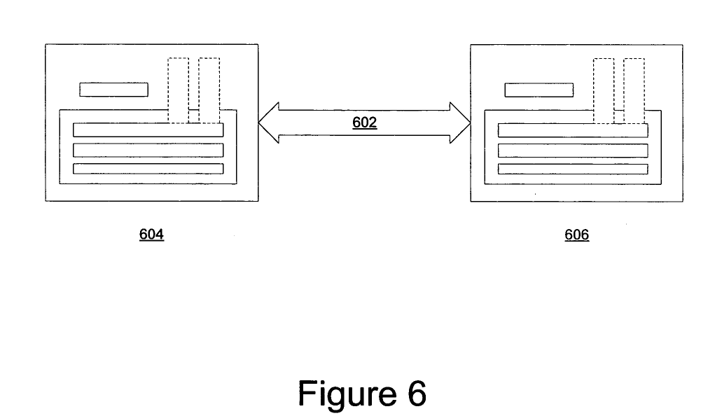

With reference now to FIG. 6, a block diagram illustrating retrieval of digital assets is depicted in accordance with one embodiment of the present invention. Rather than have digital assets in a central repository which would soon become obsolete as users within the enterprise create and store digital assets on local media, the digital assets in the present invention are stored in a distributed manner. Thus, each lKM server has a local digital asset repository as described above with reference to FIG. 5. Therefore, when a user desires to retrieve a digital asset, rather than retrieve the asset from a centralized location, the lKM server 602 queries the “golden” registry for the location of the digital asset and then requests and receives the digital asset from the lKM server 606 on whose local digital asset repository the digital asset is maintained. (It should be noted that as far as lKM server 602 is concerned, all three layers o the lkMs are exchanging information, with the communication layer using a standard protocol to convey the data that the security and business rules layers wish to send.) Therefore, failure of a digital asset repository does not paralyze the entire enterprise since not all digital assets are stored in a central location.

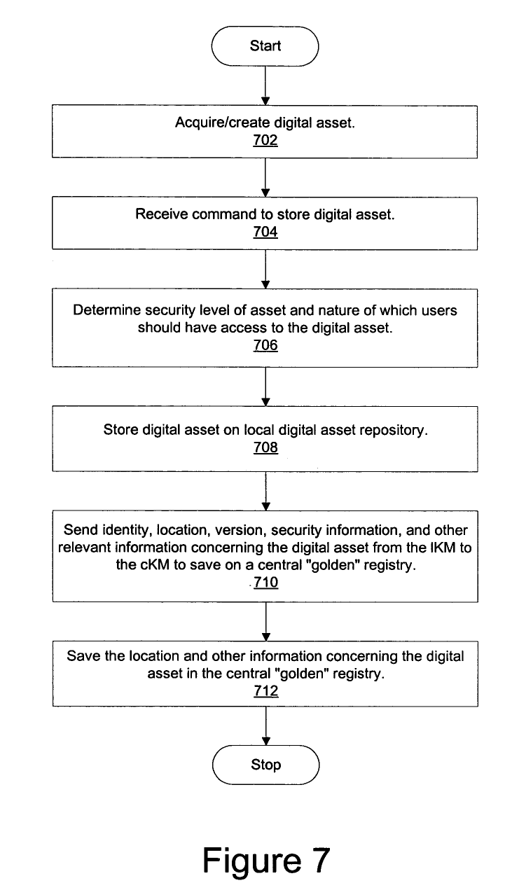

With reference now to FIG. 7, a process flow and program function diagram illustrating registration and storage of a digital asset is depicted in accordance with one embodiment of the present invention. To begin, a user creates or otherwise obtains a digital asset (step 702). The lKM server then receives a command from the user to store the digital asset (step 704). The lKM server then determines the security level of the asset and the nature of which users should have access (e.g., local group only, global group, anyone, only users who supply appropriate password, etc.) to the digital asset (step 706). This may be done either by presenting the user with a set of questions to answer or by some rule based method based on the identity of the user, the group to which the user belongs, and other similar data. Once the security level of the asset and nature of which users should have access to the digital asset are determined, the digital asset is stored on a local digital asset repository, such as, for example, local digital asset repository 504 in FIG. 5 (step 708). The lKM server then sends the identity, storage location, security information, and any other relevant information concerning the digital asset that is desired in the particular embodiment of the invention to the cKM, such as, for example, cKM 104 in FIG. 1, to save on the central “golden” registry of digital assets, such as, for example, golden registry 114 (step 710). The cKM then saves the location and other relevant information concerning the digital asset in the central “golden” registry of digital assets (step 712).

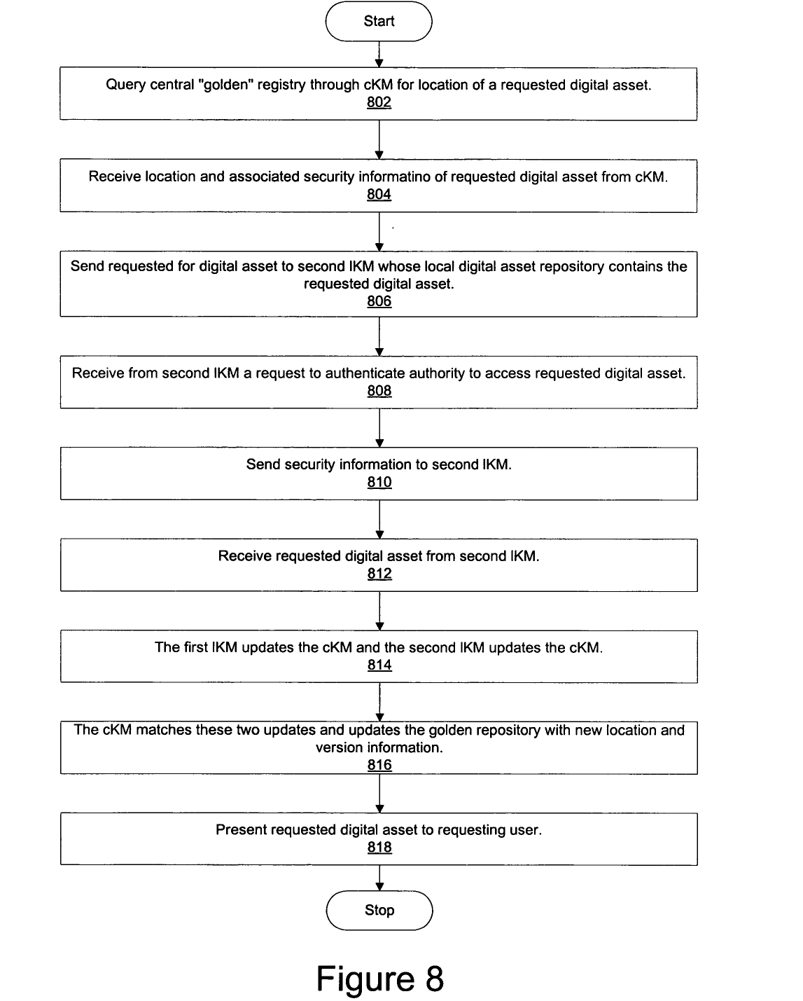

With reference now to FIG. 8, a diagram illustrating program function and process flow for retrieving a digital asset is depicted in accordance with one embodiment of the present invention. The lKM user interface will allow the user to access digital assets through two means—one by a search for an asset or by displaying a list of available assets based on user chosen criteria. The asset list will display the asset characteristics including thumbnails (if any for graphical assets), size, location, internal chargeback costs (if any), in-house or third-party asset and so on. The user then makes the request for an asset or a set of assets. The lKM server, after receiving the request from a user, queries the central “golden” registry via the cKM for the current location(s) and security constraints of the requested digital asset (step 802). The cKM locates the entry for the requested digital asset within the central “golden” registry and sends the information about the requested digital asset to the requesting lKM. Thus, the lKM receives the location(s) and corresponding security constraint information of the requested digital asset(s) from the cKM (step 804).

Using the “closest peer” algorithm based on network parameters, user over-rides, size of asset, security limitations and nature of asset the lKM then sends a request for the digital asset to a second lKM on whose local digital asset repository the requested digital asset is contained (step 806). The requesting lKM then may receive a request from the second lKM to authenticate that the requesting user has authority to access the requested digital asset (step 808). The requesting lKM then sends authenticating information, such as, for example, a password to the second lKM (step 810). If the second lKM is satisfied that the request is authorized, then the second lKM retrieves the digital asset from its local digital asset repository and sends it to the requesting lKM. The requesting lKM then receives the requested digital asset from the second lKM (step 812). Then the requesting lKM updates the cKM and the second lKM updates the cKM (step 814). The cKM then matches these two updates and updates the golden repository with the new location and version information (step 816). The requesting lKM presents the requested digital asset to the requesting user (step 818).

In some embodiments, the requesting lKM may know in advance (e.g., it may be obtained from the cKM along with the location of the requested digital asset) what type of authenticating information is required by the second lKM in order for the requesting lKM to receive the requested digital asset, thus eliminating the need for step 808 by presenting the required certificates along with the original request.

The process flows and program functions illustrated in FIGS. 7 and 8 are intended merely as examples and not as limitations of the present invention. Those skilled in the art will recognize many modifications that may be made to these process flows and program functions without departing from the scope or spirit of the present invention.

The present invention provides numerous advantage over the prior art. For example, to the users of the system, it is transparent whether the digital asset is available locally or remotely. Unless the user interface is configured by the user to display location information, all the communication and asset transfer takes place behind the scenes. Furthermore, the lKM interface is the common interface across all geographies, multiple digital management systems, organization boundaries and such. So users need to learn to use only one interface even though the enterprise could possibly have varied sets of digital asset management systems in place.

It is also important to note that whether a company has a single digital asset management system, multiple digital asset management systems or no digital asset management system, it is most practical to create a central repository of meta data about the digital assets. This provides centralized control with decentralized operations, which is how all organizations are structured. If the enterprise or company has no local digital asset management system, the lKM provides the basic digital asset management functions. Furthermore, centralized acquisition, ingestion, and re-purposing of digital assets is not practical. (It is like having all your employees in one location—okay when you are small, impossible when you are a global enterprise). Local acquisition, local ingestion and global re-purposing in accordance with the present invention is most practical.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. This embodiment was chosen and described in order to best explain the principles of the invention, the practical application, and to enable others of ordinary skill in the art to understand the invention for various embodiments with various modifications as are suited to the particular use contemplated.

1. A system for managing digital assets in a distributed data processing system, the system comprising:
a network of data processing systems;
a plurality of local knowledge management servers connected to the network wherein each of the plurality of local knowledge management servers is connected to and maintains a local digital asset repository;
a central knowledge management server; and
a central registry of digital assets; wherein
each of the plurality of local knowledge management servers sends location and identifying information concerning a digital asset to the central knowledge management server whenever a digital asset is saved to a local digital asset repository corresponding to an appropriate one of the plurality of knowledge management servers; and
the central knowledge management server stores the location and identifying information concerning the digital asset in the central registry of digital assets.

2. The system as recited in claim 1, wherein each of the plurality of local knowledge management servers presents a user interface to a user to allow the user to access digital assets stored on any one of the local digital asset repositories within the network.

3. The system as recited in claim 3, wherein the user interface allows the user to perform administrative tasks and set up local work flows.

4. The system as recited in claim 1, wherein the central knowledge management server authenticates local knowledge management servers before accepting information from the local knowledge management server for storage on the central registry of digital assets.

5. The system as recited in claim 1, wherein the central knowledge management server performs at least one of providing access to the central registry of digital assets to local knowledge management servers, enables automatic check-in/check-out of digital assets into the central registry of digital assets, provides version control of digital assets, provides a shadow registry for redundant copies of digital assets, and captures statistics of and about the digital assets.

6. The system as recited in claim 1, wherein the central knowledge management server provides at least one of generating reports based on digital asset usage, generating reports based on digital asset type, generating reports based on business unit, generates reports based on geography, and generates reports based on revenues.

7. The system as recited in claim 1, wherein a one of the plurality of local knowledge management servers retrieves the location of a requested digital asset by querying the central knowledge management server and, once the location of the requested digital asset is determined, retrieves the requested digital asset directly from another one of the plurality of local knowledge management servers on whose corresponding local digital asset repository the requested digital asset is located.

8. The system as recited in claim 1, wherein the digital assets comprise at least one of text, audio, video, photographs, and graphics.

9. A method of managing digital assets in a distributed data processing system, the method comprising:
receiving a request to store a digital asset;
storing the digital asset on a local digital asset repository; and
sending information to a central registry of digital assets, wherein the information indicates the identity of the digital asset and the location that the digital asset is stored.

10. The method as recited in claim 9, further comprising:
determining a security level of the digital asset; and
sending security level information to the central registry of digital assets.

11. The method as recited in claim 9, wherein sending information to a central registry of digital assets comprises:
sending the information from a local knowledge management server to a central knowledge management;
authenticating at the central knowledge management server that the local knowledge management server is authorized to save digital asset information to the central registry of digital assets; and
saving, by the central knowledge management server, the information in the central registry of digital assets if the local digital asset management server is authorized.

12. The method as recited in claim 11, further comprising:
refraining, at the central knowledge management server, from saving the information in the central registry of digital assets if the local knowledge management server is not authenticated.

13. A computer program product in a computer readable media for use in a data processing system for managing digital assets in a distributed data processing system, the computer program product comprising:
first instructions for receiving a request to store a digital asset;
second instructions for storing the digital asset on a local digital asset repository; and
third instructions for sending information to a central registry of digital assets, wherein the information indicates the identity of the digital asset and the location that the digital asset is stored.

14. The computer program product as recited in claim 13, further comprising:
fourth instructions for determining a security level of the digital asset; and
fifth instructions for sending security level information to the central registry of digital assets.

15. The computer program product as recited in claim 13, wherein sending information to a central registry of digital assets comprises:
fourth instructions for sending the information from a local knowledge management server to a central knowledge management server;
fifth instructions for authenticating at the central knowledge management server that the local knowledge management server is authorized to save digital asset information to the central registry of digital assets; and
sixth instructions for saving, by the central knowledge management server, the information in the central registry of digital assets if the local knowledge management server is authorized.

16. The computer program product as recited in claim 15, further comprising:
seventh instructions for refraining, at the central knowledge management server, from saving the information in the central registry of digital assets if the local knowledge management server is not authenticated.

17. A system for managing digital assets in a distributed data processing system, the system comprising:
first means for receiving a request to store a digital asset;
second means for storing the digital asset on a local digital asset repository; and
third means for sending information to a central registry of digital assets, wherein the information indicates the identity of the digital asset and the location that the digital asset is stored.

18. The system as recited in claim 17, further comprising:
fourth means for determining a security level of the digital asset; and
fifth means for sending security level information to the central registry of digital assets.

19. The system as recited in claim 17, wherein sending information to a central registry of digital assets comprises:
fourth means for sending the information from a local knowledge management server to a central knowledge management server;
fifth means for authenticating at the central knowledge management server that the local knowledge management server is authorized to save digital asset information to the central registry of digital assets; and
sixth means for saving, by the central knowledge management server, the information in the central registry of digital assets if the local knowledge management server is authorized.

20. The system as recited in claim 19, further comprising:
seventh means for refraining, at the central knowledge management server, from saving the information in the central registry of digital assets if the local knowledge management server is not authenticated.
